(19) United States
(12) Patent Application Publication
(10) Pub. No.: US 2026/0275644 A1
(43) Pub. Date: Sep. 17, 2026

(54) SWELLABLE CLAY CONTAINING WATER-BASED BARRIER COATING AND METHOD OF MAKING THE SAME

(71) Applicant: Specialty Minerals (Michigan) Inc., Plymouth, MI (US)

(72) Inventors: Pradnya Dilip Rao, Allentown, PA (US); Sherman David Cox, Allentown, PA (US)

(21) Appl. No.: 19/167,585

(22) PCT Filed: Mar. 22, 2024
(86) PCT No.: PCT/US2024/021185

§ 371 Date: Sep. 22, 2025

Related U.S. Application Data
(60) Provisional application No. 63/454,558, filed on Mar. 24, 2023.

(51) Int. Cl. D21H 21/16; C09D 5/02; C09D 7/61; C09D 7/80; D21H 19/40; D21H 19/44

(52) U.S. Cl. CPC D21H 21/16; C09D 5/022; C09D 5/028; C09D 7/61; C09D 7/80; D21H 19/40; D21H 19/44

(57) ABSTRACT

An aqueous barrier coating for paper products can include a chemically unmodified swellable clay dispersed in a binder, wherein the swellable clay is dispersed under high shear conditions such that the swellable clay is present in the form of tactoids.

### CROSS-REFERENCE TO RELATED APPLICATION

The benefit of priority to U.S. Provisional Patent Application No. 63/454,558 filed Mar. 24, 2023, is hereby claimed and the disclosure is incorporated herein by reference in its entirety.

### FIELD

The disclosure relates to water-based barrier coatings and methods of making water-based barrier coatings containing swellable clay.

### BACKGROUND

Paper-based packaging materials are utilized around the world. Currently, the barrier coatings of paper and packaging applications primarily depend on petroleum-based materials and synthetic polymers such as waxes, polyvinyl alcohol, polyolefins (Gironi & Piemonte, 2011). These materials are cost-effective, easily available, and provide a significant barrier against water vapor, oil/grease, and oxygen for packaging applications. However, these materials have major disadvantages such as poor recyclability of coated paper and non-biodegradability which can adversely impact the environment. Ideal packaging material in the context of food packaging must have a good barrier to oxygen, water vapor, and oil/grease while being derived from biobased, recyclable, compostable, and/or otherwise ecofriendly sources. Barrier property needs can vary depending on the coating application and ultimate use of the paper product.

Nanoclays have been used in a variety of applications and are generally found advantageous for their ability to swell in water. Sun et al reported a nanoclay/latex composite for improving barrier properties in coatings. See Sun et al., Comps Science Tech 67 (2007) 1823-1829. Consistent with conventional expectations and uses of nanoclays, Sun et al. teaches that the nanoclay must be fully exfoliated in the coating and that cationic surface modifications of the clay and/or use of dispersants was required. Specifically, Sun concludes that the barrier properties of the polymer/clay nano-composites strongly depended on the exfoliation degree of the nanoclay layers and that full exfoliation was necessary to get good barrier performance.

### SUMMARY

In accordance with the disclosure, a process for preparing an aqueous barrier coating for a paper substrate can include admixing a dry powder of a chemically unmodified swellable clay with a binder; and subjecting the admixture to high shear mixing under conditions such that the swellable clay disperses in the binder and at least a portion of the swellable clay maintains a tactoid form to thereby form the barrier coating. The binder can be water-based or water-soluble.

In accordance with the disclosure, a process for preparing an aqueous barrier coating for a paper substrate can include admixing a dry powder of a chemically unmodified swellable clay with a polymer latex binder; and subjecting the admixture to high-shear mixing under conditions such that the swellable clay disperses in the polymer latex and at least a portion of the swellable clay maintains a tactoid form to thereby form the barrier coating.

The process in accordance with the disclosure can further include coating a paper substrate with the barrier coating.

In accordance with the disclosure, an aqueous barrier coating can include chemically unmodified swellable clay dispersed in a binder, wherein the swellable clay is dispersed under high shear conditions such that the swellable clay is present in the form of tactoids.

The coating can be free of dispersant.

### BRIEF DESCRIPTION OF THE DRAWINGS

FIG. 1 is a scanning electron microscopy image of a coating in accordance with the disclosure, showing tactoids of sodium bentonite being present in the coating.

FIG. 2 is a graph showing water vapor transmission rate performance for coatings in accordance with the disclosure and conventional coatings formed as single layer coatings and tested under tropical conditions.

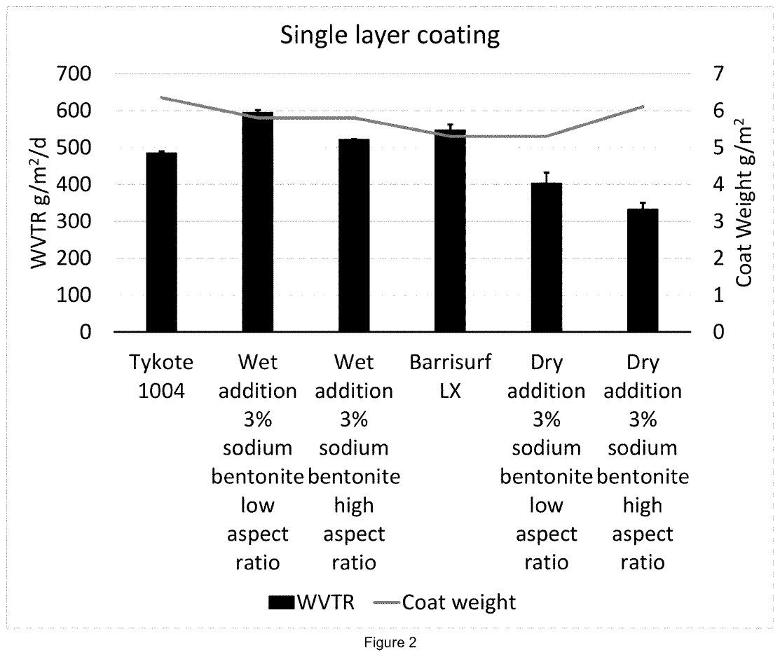

FIG. 3 is a graph showing water vapor transmission rate performance for coatings in accordance with the disclosure and conventional coatings formed as double layer coatings and tested under tropical conditions.

### DETAILED DESCRIPTION

Water-based coatings in accordance with the disclosure include a chemically unmodified swellable clay dispersed in a binder to provide a barrier coating that is aqueous based. It has been advantageously found that barrier coating properties can be achieved through the incorporation of dry swellable clay. The swellable clay used in the coatings as the raw starting material can be in its natural, unexfoliated state. Exfoliation of the swellable clay can occur under the high shear mixing conditions used in dispersing the sodium bentonite in the binder when preparing the coatings of the disclosure. Advantageously, no pre-processing of the swellable clay is needed before dispersing within the binder.

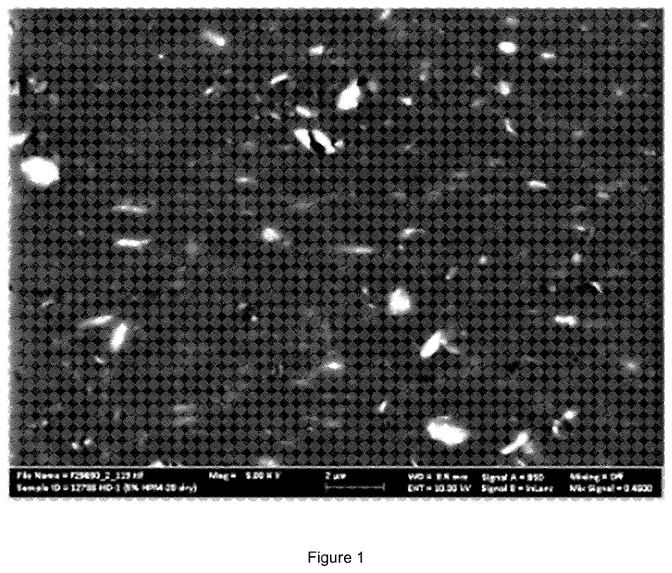

Coatings of the disclosure include a chemically unmodified swellable clay dispersed in a binder using high shear mixing conditions such that at least a portion of the swellable clay is present in the coating in the form of tactoids. The coatings of the disclosure can be aqueous-based barrier coatings. FIG. 1 is an SEM image of a coating in accordance with the disclosure having sodium bentonite as the swellable clay showing the presence of tactoids.

Methods of making aqueous based barrier coatings in accordance with the disclosure can include admixing a dry powder of a chemically unmodified swellable clay with a binder and subjecting the admixture to high shear mixing under conditions such that the swellable clay disperses in the binder and at least a portion of the swellable clay maintains a tactoid form.

The swellable clay can include one or more clay minerals including, but not limited to smectite, nontronite, bentonite, montmorillonite, beidellite, and vermiculite. The swellable clay can be chemically unmodified and optionally can be mechanically unmodified. As used herein, “mechanically unmodified swellable clay” refers to swellable clay that has not been subject to mechanical shearing, such as for exfoliation, prior to incorporation into a coating, and that retains its natural hydrophilic state. As used herein, “chemically unmodified swellable clay” refers to swellable clay that has not been subject to chemical modification, such as with organic modifiers. In some coatings of the disclosure, the swellable clay admixed with the binder is chemically and mechanically unmodified and optionally exfoliated during dispersion of the swellable clay in the binder thereby modifying the clay present in the final coating by mechanical shearing. In some coatings of the disclosure, the swellable clay admixed with the binder is chemically unmodified. In some coatings of the disclosure, the swellable clay present in the coating is chemically unmodified.

The swellable clay used in the coatings and methods of the disclosure can have less than about 12% moisture. The swellable clay is incorporated into the binder of the coatings in a dry particulate or powder state, without pre-swelling or exfoliation, and dispersed in the binder using high shear mixing. High shear mixing conditions can be selected and tailored to provide for exfoliation of the swell able clay while dispersing the sodium bentonite in the binder. It has been found that use of a swellable clay that has been exfoliated during dispersion results in high shape factor swellable clay being present in the final coating. High shaper factor as used herein refers to a shape factor above 4 as measure by the ratio of the Horiba d₅₀ measured with static light scattering to the Zave particles size measured with dynamic light scattering. Exfoliation during dispersion within the binder can increase the shape factor of the swellable clay, while allowing a portion of the swellable clay to be maintained in tactoid form.

Referring to FIG. 1, it has been observed that in the coatings of the disclosure, at least a portion of the swellable clay is maintained in a tactoid form. It was surprisingly found that improved barrier coating properties were achieved without full exfoliation of the swellable clay and, instead, with maintenance of at least a portion of the swellable clay in tactoid form. It has been observed that the use of the dry powder form of the swellable clay combined with the high-shear mixing used to disperse the swellable clay in the binder allows the swellable clay to be incorporated into the coatings such that tactoids are present and dispersed in the binder.

The coatings of the disclosure have been observed to achieve improved barrier properties, as compared to conventional talc and kaolin containing coatings. The coatings of the disclosure can achieve comparable, if not improved, barrier coating properties, as compared to talc or kaolin containing coatings with significantly reduced loading levels of the swellable clay. Additionally, the coatings of the disclosure can be formed without the need for added dispersant.

The swellable clay is dispersed in the binder using high shear mixing conditions that achieve a coating in which at least a portion of the swellable clay is present in tactoid form. Such high shear mixing can be achieved, for example, by mixing with a tip speed of about 655 ft/min to about 3300 ft/min (200 m/min to 1010 m/min). High shear mixing can be performed using any known methods or combinations of methods, including, but not limited to, using a Cowles mixer, sonication, and rotor-stator mixing. High shear mixing can include, for example, sonication for at least 1 min. Sonication times can be about 1 min to about 40 min, about 10 min to about 30 min, or about 5 min to about 25 min. Other suitable times include about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, and 40 mins and values therebetween and ranges defined by those values. High shear can be performed for example under conditions to reduce or protect against overheating. For example, sonication can be performed using a jacketed vessel with water circulation and a pulsing method to prevent overheating.

The coating can include any suitable aqueous binder. For example, the binder can be an aqueous polymer latex. For example, non-latex binders can also be used. For example, binders can be one or more of an anionic polymer latex, such as Styrene butadiene, polyolefin, styrene acrylates, ethylene acrylic acid copolymers, ethylene vinyl alcohol copolymers, polyurethanes, epoxy resins, polyesters, polyolefins, carboxylated styrene-butadiene latexes, carboxylated styrene acrylate latexes; polyvinylidene chlorides; polyvinyl chlorides; starches; styrene-acrylic copolymers; styrene-maleic anhydrides; polyvinyl alcohols; polyvinyl acetates; carboxymethyl celluloses; silicones; waxes; neoprene; polyhydroxy ethers; lacquers; polylactic acids; copolymers of polylactic acid; polymers containing fluorine atoms; copolymers of acrylonitrile; and carboxylated styrene-butadiene acrylonitrile copolymers.

The swellable clay can be added to the binder in amounts of about 1 wt % to about 20 wt %, about 1 wt % to about 5 wt %, about 3 wt % to about 15 wt %, or about 10 wt % to about 20 wt %, based on a total weight of the coating on a dry weight basis. Other suitable amounts include, based on a total weight of the coating on a dry weight basis, of about 1, 2, 3, 4, 5, 6, 7, 8, 9, 10, 11, 12, 13, 14, 15, 16, 17, 18, 19, and 20 wt %, and any values therebetween, and any ranges defined by such values. Unless specified otherwise, reference to a precent (%) of swellable clay in the coatings of the disclosure refers to a weight percent based on a total weight of the coating on a dry weight basis. Loading levels of swellable clay can be significantly lower than required with talc or kaolin in conventional coatings, while maintaining or even exhibiting improved barrier properties. For example, the swellable clay loading in the coatings of the disclosure can be 2 to 60 times lower than required for other platy minerals-based barrier coatings, such as talc or kaolin coatings.

The coatings of the disclosure are for use in coating porous substrates, such as paper and paperboard. For suitability in such applications, the coatings of the disclosure can have a solids content of about 5% to about 55%, about 15% to about 55%, about 20% to about 40%, about 30% to about 50%, or about 10% to about 25%. Other suitable solids content includes about 5, 10, 15, 20, 25, 30, 35, 40, 45, 50, 55% and any values therebetween and ranges defined by such values.

Coatings prepared by the dry addition of the swellable clay can advantageously have solids contents that are equal to or greater than the solids content of the binder. In contrast, coatings prepare with wet addition of the swellable clay have lower solids content than the binder as a result of the liquid present in the slurry of the sodium bentonite.

The coatings of the disclosure can be coated by conventional paper coating methods, such as drawdown coating, blade coating, curtain coating, rotogravure coating (gravure coating), machine roll-to-roll coating, size press, reverse roll coating, hot melt coating flexbar coating/Flexo coating, film transfer coating, die-slot coating, wet film applicator coating, coating film casting using filtration and evaporation, dip coater, or extrusion coating. The substrate can be coated, for example, with any desired coating weight and/or number of coating layers. For example, the coatings can be coated with a coating weight of about 1 g/m² to about 35 g/m², about 1 g/m² to about 25 g/m², about 5 g/m² toa bout 15 g/m². For example, the coating weight can be about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, or 35 g/m² and any values therebetween or ranges defined by such values.

The coatings of the disclosure can be a single layer coating and have a coat weight of less than 10 g/m², for example, about 2 g/m² to less than 10 g/m², or about 4 g/m² to about 8 g/m². Other suitable single-layer coat weights can include about 1, 2, 3, 4, 5, 6, 7, 8, and 9 g/m² and any values therebetween and ranges defined by such values. It has been advantageously observed that the beneficial effects of the coatings of the disclosure, including a swellable clay as opposed to kaolin or talc, can allow for single layer coatings to be used while achieving desired barrier properties. This is advantageous as double or multilayer coatings may not be practical in many applications, particularly when using multifunctional layers/coatings. At single-layer coat weights, the coatings of the disclosure demonstrated a 31% improvement in barrier properties with a 3% dry addition of sodium bentonite in the coating as compared to pure latex. Coatings of the disclosure having 3% dry addition of the sodium bentonite also demonstrated a 39% improvement over a competitive product Barrisurf™ LX, which includes 40% kaolin clay. Dry addition of the sodium bentonite in the coating demonstrated a more than 30% improvement in barrier properties as compared to wet addition.

The porous substrates for use with coatings of the disclosure can generally include any paper or paperboard products for which a barrier coating is desired. Paper substrates onto which the coatings of the disclosure can be coated can include, but are not limited to, solid bleached sulfate (SBS) paper, folding box board (FBB), white top liner (WTL), low basis weight papers such as fast-food wrappers, copy paper, coated and uncoated paper and paperboard, coated unbleached kraft (CUK) paper, and coated recycled paperboard.

Coatings of the disclosure can be tailored to provide water vapor transmission rates or other barrier properties based on intended application of the paper substrate. For example, the barrier coating can provide a <40 g/m²/d water vapor transmission rate (WVTR) at tropical conditions (38° C. and 90% RH), and/or water COBB 60 mins <1 g/m². It is generally understood in the art that WVTR at tropical conditions for ultra-high barrier applications is <10 g/m²/d, high barrier applications is <100 g/m²/d, medium barrier applications is 100-400 g/m²/d, and low barrier >400 g/m²/d. Barrier coatings in accordance with the disclosure can be tailored for any of the foregoing applications.

### EXAMPLES

The following examples demonstrate the performance of a coating in accordance with the disclosure using sodium bentonite as the swellable smectite clay. It is believed that the results demonstrated herein are extendible to other swellable clays, as they exhibit similar performance with respect to swelling when exposed to water and exfoliating under the high shear mixing conditions while maintaining a portion of the clay in tactoid form.

### Example 1: Determining Shape Factor and Mixing Conditions Effect on Shape Factor

Raw, chemically unmodified sodium bentonite having a moisture content of 8% and a dry particle size of a minimum 99.00% finer than 200 mesh (74 microns) and wet particle size of a minimum of 99.75% finer than 200 mesh (74 microns). The particle size of dispersed sodium bentonite was determined using the Horiba LA950 static light scattering instrument. A 1.0% bentonite suspension was created by adding 0.5 μm of bentonite powder to 50 ml of a D.I. water solution with a 0.005% DAXAD® 30 dispersant concentration. The resulting suspension was sonicated using 0.5-inch horn at setting 1.5, for 8 minutes to disperse it. The dispersed suspension was added dropwise to the Horiba LA950 cell to achieve a red laser % transmittance of 89-91%, and the particle size was determined using standard settings and refractive indices for calcium carbonate. This method measures a particle size related to the larger, basal plane dimension of the bentonite.

Undispersed sodium bentonite samples were also tested. A water suspension of sodium bentonite at any solids content from about 1 to 10% can be prepared and varying degrees of shear may be applied using any type of mixing or sonication equipment. This suspension is added to the Horiba LA950 cell and particle size measured as described above.

TABLE 1

| | D10 | D20 | D50 | D90 | D95 | D98 |
|---|---|---|---|---|---|---|
| Description | (μm) | (μm) | (μm) | (μm) | (μm) | (μm) |
| Sodium Bentonite - dispersed, | 1.19 | 1.57 | 2.83 | 8.77 | 11.71 | 15.73 |
| sonicated | | | | | | |
| Sodium Bentonite - in water, | 1.47 | 1.88 | 3.12 | 6.76 | 8.31 | 10.31 |
| shear 2 hours with rotor-stator | | | | | | |

The particle size of sodium bentonite was also determined by the dynamic light scattering (DLS) technique using a Malven Zetasizer 1000 instrument. Either a dispersed or undispersed suspension can be used. The suspension was diluted to 0.1% solids using DI water. The diluted suspension was transferred to an instrument cuvette (1 cm×1 cm plastic with all faces transparent), and the cuvette placed in the instrument measurement chamber. Standard software settings were used to measure size using water as a solvent and refractive index of sodium bentonite (1.503). The resulting Zave value (the hydrodynamic diameter) is reported. This instrument is designed to measure nanoparticles and hence we used this technique to provide a value related to, though much larger than the smaller thickness dimension of the sodium bentonite plates. Measured Zave values of sodium bentonite varied from 500 to 1500 nm.

It was determined that shape factor (SF) of bentonite could be calculated as a ratio of two particle size methods—using the ratio of diameters from static light scattering (Horiba LA-950) to diameters from dynamic light scattering (DLS). With bentonite, it was observed that sedimentation could not be used due to it extremely long settling time. The shape factor (SF) was calculated by taking the ratio of median particle size (d50) determined by Horiba light scattering to the Zave particle size determined using Malvern Zetasizer 1000 DLS in microns. The resulting SF values for sodium bentonite may vary from 3.5 to 7, with higher values indicating a higher degree of delamination and higher particle aspect ratio.

Two samples with high and low SF were made as follows:

Low SF: A 5% solids sodium bentonite slurry in DI water was made by adding 27.8 μm of dry sodium bentonite at 10% moisture to 472.2 μm of water. Then using a Premier model 2500HV Cowles-type mixer with a 2.5-inch (6.35 cm) diameter blade, the suspension was stirred at 2000 rpm or a tip speed of 1310 ft/min for 5 minutes. Using the oven drying method the solid content of this water-based sodium bentonite slurry was determined to be 5%.

High SF: Another 500 mL of 5% solids starting slurry was sonicated for a total of 20 minutes in a water-cooled beaker with constant mixing with a propeller stirrer. To avoid heating, sonication was turned on and off in 10 seconds on/20 seconds off cycles for a total of 20 minutes on time.

TABLE 2

| | Hor | Hor | Hor | ZS Zave | SF |
|---|---|---|---|---|---|
| Description | d10 | d50 | d90 | (um) | (Hd50/Zave) |
| Cowles 2000 rpm, 5 min. | 2.10 | 4.30 | 8.23 | 1.11 | 3.87 |
| Sonication 20 min. | 1.13 | 2.91 | 9.12 | 0.548 | 5.31 |

This demonstrates that the mixing method used to disperse the sodium bentonite within the binder can be selected to produce a final composition with high or low shape factor sodium bentonite present therein. High shear mixing methods, such as sonication, was observed to result in high shape factor materials.

### Example 2: Barrier Performance Testing

Coatings in accordance with the disclosure were prepared having high and low shaped factor sodium bentonite, as well as with dry and wet addition of the sodium bentonite. The chemically unmodified sodium bentonite as described in Example 1 was used as the starting material in the coatings of the disclosure. The coatings in accordance with the disclosure each included 3 wt % sodium bentonite based on the total weight of the composition on a dry weight basis. Barrier performance of these coatings were compared to each other, as well as to a coating of Tykote® 1004 (pure latex) and a Barrisurf™ LX (kaolin) containing coating.

A coating in accordance with the disclosure having dry addition of 3% sodium bentonite with a low shape factor was prepared by combining 150 g of Tykote® 1004 with 2.6 g of dry sodium bentonite powder. To create the low shape factor formulation, this mixture was stirred at 2000 RPM for 5 minutes using a 2.5-inch diameter Cowles blade. The formulation was diluted to 47% by adding DI water. This formulation was kept overnight then viscosity, pH, and solids were measured.

A coating in accordance with the disclosure having dry addition of 3% sodium bentonite with a high shape factor was prepared by combining 150 g of Tykote® 1004 with 2.6 g of dry sodium bentonite powder. For the high shape factor formulation, this mixture was stirred at 2000 RPM for 5 minutes, followed by sonication for 20 minutes with a pulsing function, alternating between 30 seconds on and 30 seconds off. The pulsing function was used to prevent overheating. The formulation was diluted to 47% by adding DI water. This formulation was kept overnight then viscosity, pH, and solids were measured.

A coating in accordance with the disclosure having wet addition of 3% sodium bentonite with a low shape factor was prepared by first forming a sodium bentonite slurry. The slurry was prepared as described in Example 1 for preparing a low shape factor sodium bentonite slurry. In particular, 25 g of sodium bentonite dry powder was mixed with 475 g of water, sheared at 2000 RPM for 5 minutes using 2.5-inch Cowles blade to achieve a final bentonite slurry solids concentration of 5%. Subsequently, 150 g of Tykote® 1004 were combined with 48.2 g of the wet 5% sodium bentonite slurry. The Tykote® 1004 latex and sodium bentonite slurry were then mixed at 800 RPM for 15 minutes using a propeller-type overhead mixer. This formulation was kept overnight then viscosity, pH, and solids were measured.

A coating in accordance with the disclosure having wet addition of 3% sodium bentonite with a high shape factor was prepared by first forming a sodium bentonite slurry. The slurry was prepared as described in Example 1 for preparing a high shape factor sodium bentonite slurry. In particular, 25 g of sodium bentonite dry powder was mixed with 475 g of water, sheared at 2000 RPM for 5 minutes using 2.5-inch Cowles blade. Further to achieve a high shape factor, the same formulation was sonicated for 20 minutes with a pulsing function, alternating between 10 seconds on and 20 seconds off. The pulsing function was used to prevent overheating. The final solids of sodium bentonite slurry was 5%, 150 g of Tykote® 1004 were combined with 48.2 g of the wet 5% sodium bentonite slurry. The Tykote® 1004 latex and sodium bentonite slurry were then mixed at 800 RPM for 15 minutes using a propeller-type overhead mixer. This formulation was kept overnight then viscosity, pH, and solids were measured

The Barrisurf™ LX (kaolin) comparative example coating was prepared as a 40% Barrisurf™ LX-Tykote® 1004 formulation. 150 g of Tykote® 1004 were combined with 84.4 g of Barrisurf™ LX slurry. Barrisurf™ LX slurry had a solid content of 61.6%. This mixture was then blended at 800 RPM for 15 minutes using a propeller-type overhead mixer. This formulation was kept overnight then viscosity, pH, and solids were measured.

For each of the coating formulations, the coatings were applied to 175 g/m² white top liner using an automated draw-down coater at a speed of 40 m/min. The coatings underwent drying in the oven at 103° C. for 10 minutes, followed by conditioning in the CTH room for 24 hours. Both single and double layers of coating were applied. For the single-layer coating, the targeted coat weight was 5.8±0.4 g/m², while for the double-layer coating, the targeted coat weight was 10.8±0.3 g/m². Subsequently, circles with a diameter of 7.62 cm were cut and utilized for WVTR testing under tropical conditions.

Table 3 provides the viscosity, pH, and solids content of the coating formulations prepared.

TABLE 3

| | Viscosity 100 | | % |
|---|---|---|---|
| Sample Description | RPM-cP | pH | Solids |
| Tykote ® 1004 | 270 | 8.08 | 52% |
| Barrisurf ™ Lx | 106.8 | 8.13 | 55.4% |
| Low shape factor wet addition | 75 | 8.36 | 40.3% |
| 3% sodium bentonite | | | |
| High shape factor wet addition | 206 | 8.36 | 40.1% |
| 3% sodium bentonite | | | |
| Low shape factor dry addition | 180 | 8.32 | 47.1% |
| 3% sodium bentonite | | | |
| High shape factor dry addition | 650 | 8.03 | 46.1% |
| 3% sodium bentonite | | | |

*3% sodium bentonite refers to 3 wt % sodium bentonite based on the total weight of the coating on a dry weight basis.

Water vapor transmission rate was tested by (WVTR) by TAPPI T 464 under tropical conditions. Referring to FIG. 7, single layer coatings of the disclosure demonstrated a significant improvement in water vapor transmission rate properties as compared to the Tykote®-1004 only coating and the Barrisurf™ LX (kaolin) containing coating. Additionally, an improvement in water vapor transmission rate performance was also observed for the dry addition of the sodium bentonite in the coatings of the disclosure as compared to the wet addition. Finally, improvement in water vapor transmission rate performance was also observed when using a process of formulating the coating that results in a high shape factor sodium bentonite being present in the coating. In particular, the following quantitative improvements in performance were observed:

A 31% reduction in WVTR for 3% dry addition high aspect ratio compared to pure latex.

A 36% reduction in WVTR for high aspect ratio dry addition compared to high aspect ratio wet addition.

A 32% reduction in WVTR for low aspect ratio dry addition compared to low aspect ratio wet addition.

A 39% reduction in WVTR for 3% dry addition high aspect ratio compared to Barrisurf™ LX

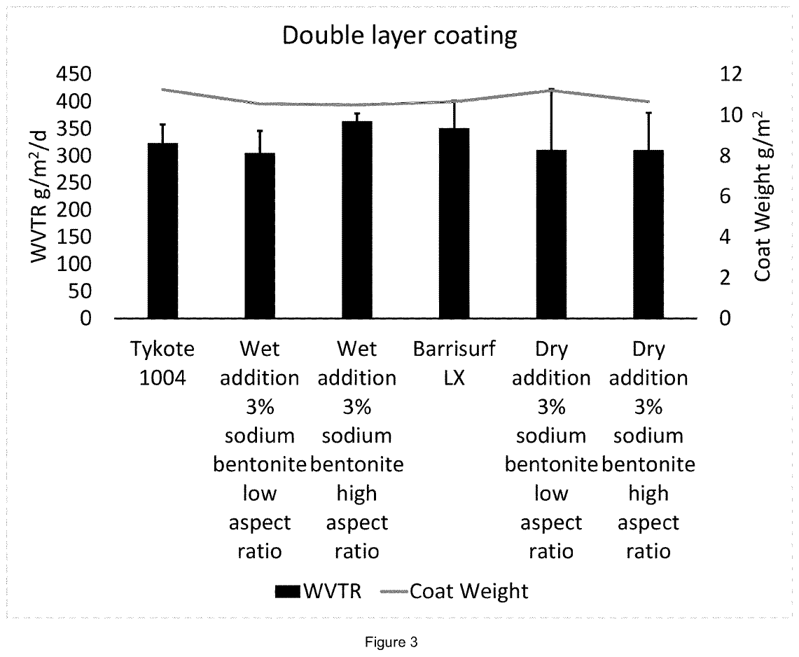

Referring to FIG. 3 the significance of the reduction in WVTR between the coatings of the disclosure and the Tykote® 1004 and Barrisurf™ LX (kaolin) comparative coatings is less pronounced when using a double layer coating. A reduction of the water vapor transmission rates is still observed, particularly with respect to the dry addition of the sodium bentonite. Further, it was surprisingly and beneficially observed that coatings in accordance with the disclosure with dry addition of the sodium bentonite with a high shape factor could provide similar or even improved water vapor transmission rate performance when formed as a single-layer coating as compared to the double layer coatings of the Tykote® 1004 and Barrisurf™ coatings. The coatings of the disclosure can, therefore, avoid the need for double layer coatings, which can be complicated and impractical in some applications, while maintaining at least the same level of barrier performance as a double layer coating of conventional kaolin coatings.

The foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In the case of conflict, the present description, including definitions, will control.

Throughout the specification, where the compounds, compositions, methods, and/or processes are described as including components, steps, or materials, it is contemplated that the compounds, compositions, methods, and/or processes can also comprise, consist essentially of, or consist of any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

What is claimed is:

1. A process for preparing an aqueous barrier coating for a paper substrate, comprising:
admixing a dry powder of chemically unmodified swellable clay with a binder; and
subjecting the admixture to high shear mixing under conditions such that the swellable clay disperses in the binder and at least a portion of the swellable clay maintains a tactoid form to thereby form the barrier coating, wherein the binder is water-based or water soluble.

2. The process of claim 1, wherein the binder comprises a polymer latex.

3. The process of claim 2, wherein the polymer latex is an anionic polymer latex.

4. The process of claim 3, wherein the anionic polymer latex comprises one or more of styrene butadiene, polyolefin, styrene acrylates, ethylene acrylic acid copolymers, ethylene vinyl alcohol copolymers, polyurethanes, epoxy resins, polyesters, polyolefins, and carboxylated styrene-butadiene.

5. The process of any one of the preceding claims, wherein the binder comprises one or more of carboxylated styrene acrylate latexes, polyvinylidene chlorides, polyvinyl chlorides, starches, styrene-acrylic copolymers, styrene-maleic anhydrides, polyvinyl alcohols, polyvinyl acetates, carboxymethyl celluloses, silicones, waxes, neoprene, polyhydroxy ethers, lacquers, polylactic acids, copolymers of polylactic acid, polymers containing fluorine atoms, copolymers of acrylonitrile, and carboxylated styrene-butadiene acrylonitrile copolymers.

6. A process for preparing an aqueous barrier coating for a paper substrate, comprising:
admixing a dry powder of chemically unmodified swellable clay with an aqueous polymer latex binder; and
subjecting the admixture to high shear mixing under conditions such that the swellable clay disperses in the polymer latex and at least a portion of the swellable clay maintains a tactoid form to thereby form the barrier coating.

7. The process of claim 6, wherein the polymer latex is an anionic polymer latex.

8. The process of claim 7, wherein the anionic polymer latex comprises one or more of styrene butadiene, polyolefin, styrene acrylates, ethylene acrylic acid copolymers, ethylene vinyl alcohol copolymers, polyurethanes, epoxy resins, polyesters, polyolefins, and carboxylated styrene-butadiene.

9. The process of any one of the preceding claims, wherein the aqueous barrier coating has a solids content of about 5% to about 55%.

10. The process of any one of the preceding claims, wherein high shear mixing is performed at a tip speed of about 655 ft/min to about 3300 ft/min (200 m/min to 1010 m/min).

11. The process of any one of the preceding claims, wherein the dry powder of chemically unmodified swellable clay comprises less than 12% moisture.

12. The process of any one of the preceding claims, wherein high shear mixing is performed using a Cowles mixer, a sonicator, or a rotor-stator mixer.

13. The process of claim 12, wherein high shear mixing is performed using a sonicator.

14. The process of claim 13, comprising sonicating for about 1 min to about 40 min.

15. The process of any one of the preceding claims, wherein the high shear mixing is performed under conditions to exfoliate the swellable clay while dispersing the swellable clay in the binder such that the swellable clay present in the coating has a shape factor of above 4 as measured by a ratio of the Horiba d50 measured with static light scattering to the Zave particle size measured with dynamic light scattering.

16. The process of any one of the preceding claims, wherein the dry powder of chemically unmodified swellable clay is added to the binder in an amount of about 1 wt % to about 20 wt % based on the total weight of the admixture on a dry weight basis.

17. The process of any one of the preceding claims, wherein the admixture is free of dispersants.

18. The process of any one of the preceding claims, wherein the chemically unmodified swellable clay is a chemically and mechanically unmodified swellable clay.

19. A process for preparing a barrier coating for a paper substrate, comprising:
admixing a dry powder of chemically unmodified swellable clay with a binder;
subjecting the admixture to high shear mixing under conditions such that the swellable clay disperses in the binder and at least a portion of the swellable clay maintains a tactoid form to thereby form the barrier coating; and
coating the paper substrate with the barrier coating with a coating weight of about 1.5 g/m² to about 25 g/m²,
wherein the binder is water-based or water soluble.

20. The process of claim 19, wherein the coating weight is less than 10 g/m².

21. The process of claim 19 or 20, wherein the paper substrate is solid bleached sulfate (SBS) paper, folding box board (FBB), White top liner (WTL), low basis weight paper wrappers, copy paper, coated or uncoated paper and paper board, Coated Unbleached Kraft (CUK), Coated Recycled Paperboard.

22. The process of any one of claims 19 to 21, wherein the binder comprises a polymer latex.

23. The process of claim 22, wherein the polymer latex is an anionic polymer latex.

24. The process of claim 23, wherein the anionic polymer latex comprises one or more of styrene butadiene, polyolefin, styrene acrylates, ethylene acrylic acid copolymers, ethylene vinyl alcohol copolymers, polyurethanes, epoxy resins, polyesters, polyolefins, and carboxylated styrene-butadiene.

25. The process of any one claims 19 to 24, wherein the binder comprises one or more of carboxylated styrene acrylate latexes, polyvinylidene chlorides, polyvinyl chlorides, starches, styrene-acrylic copolymers, styrene-maleic anhydrides, polyvinyl alcohols, polyvinyl acetates, carboxymethyl celluloses, silicones, waxes, neoprene, polyhydroxy ethers, lacquers, polylactic acids, copolymers of polylactic acid, polymers containing fluorine atoms, copolymers of acrylonitrile, and carboxylated styrene-butadiene acrylonitrile copolymers.

26. The process of any one of claims 19 to 25, wherein the aqueous barrier coating has a solids content of about 5% to about 55%.

27. The process of any one of claims 19 to 26, wherein high-shear mixing is performed at a tip speed of about 655 ft/min to about 3300 ft/min (200 m/min to 1010 m/min).

28. The process of any one of claims 19 to 27, wherein the dry powder of chemically unmodified swellable clay comprises less than 12% moisture.

29. The process of any one of claims 19 to 28, wherein high shear mixing is performed using a Cowles mixer, a sonicator, or a rotor-stator mixer.

30. The process of claim 29, wherein high shear mixing is performed using a sonicator.

31. The process of claim 30, comprising sonicating for about 1 min to about 40 min.

32. The process of any one of claims 19 to 31, wherein the high shear mixing is performed under conditions to exfoliate the swellable clay while dispersing the swellable clay in the binder such that the swellable clay present in the coating has a shape factor of above 4 as measured by a ratio of the Horiba d50 measured with static light scattering to the Zave particle size measured with dynamic light scattering.

33. The process of any one of claims 19 to 32, wherein the dry powder of chemically unmodified swellable clay is added to the binder an amount of about 1 wt % to about 20 wt % based on a total weight of the admixture on a dry weight basis.

34. The process of any one of claims 19 to 33, wherein the admixture is free of dispersants.

35. The process of any one of claims 19 to 34, wherein the chemically unmodified swellable clay is a chemically and mechanically unmodified swellable clay.

36. An aqueous barrier coating, comprising:
chemically unmodified swellable clay dispersed in a binder, wherein the swellable clay is dispersed under high shear conditions such that at least a portion of the swellable clay is present in the form of tactoids, wherein the binder is water-based or water-soluble.

37. The coating of claim 36, wherein the swellable clay has a shape factor of above 4 as measured by a ratio of the Horiba d50 measured with static light scattering to the Zave particle size measured with dynamic light scattering.

38. The coating of claim 36 or 37, wherein the binder comprises a polymer latex.

39. The coating of claim 38, wherein the polymer latex is an anionic polymer latex.

40. The coating of claim 39, wherein the anionic polymer latex comprises one or more of styrene butadiene, polyolefin, styrene acrylates, ethylene acrylic acid copolymers, ethylene vinyl alcohol copolymers, polyurethanes, epoxy resins, polyesters, polyolefins, and carboxylated styrene-butadiene.

41. The coating of any one claims 36 to 40, wherein the binder comprises one or more of carboxylated styrene acrylate latexes, polyvinylidene chlorides, polyvinyl chlorides, starches, styrene-acrylic copolymers, styrene-maleic anhydrides, polyvinyl alcohols, polyvinyl acetates, carboxymethyl celluloses, silicones, waxes, neoprene, polyhydroxy ethers, lacquers, polylactic acids, copolymers of polylactic acid, polymers containing fluorine atoms, copolymers of acrylonitrile, and carboxylated styrene-butadiene acrylonitrile copolymers.

42. The coating of any one of claims 36 to 41, wherein the aqueous barrier coating has a solids content of about 5% to about 55%.

43. The coating of any one of claims 36 to 42, wherein the swellable clay present in the coating in an amount of about 1 wt % to about 20 wt % based on a total weight of the coating on a dry weight basis.

44. The coating of any one of claims 36 to 43, wherein the coating is free of dispersants.

45. The coating of any one of claims 36 to 44, wherein the coating has a solids content equal to or greater than the solids content of the binder.

46. A barrier coated paper substrate comprising a paper substrate coated with the coating of any one of claims 36 to 45.

47. The barrier coated paper substrate of claim 46, wherein the paper substrate is solid bleached sulfate (SBS) paper, folding box board (FBB), White top liner (WTL), low basis weight paper wrapper, copy paper, coated or uncoated paper and paper board, Coated Unbleached Kraft (CUK), Coated Recycled Paperboard

48. The barrier coated paper substrate of claim 46 or 47, wherein the coating has a coat weight of less than 10 g/m² and a water transmission rate of less than 400 g/m²/d.
